(19) United States
(12) Patent Application Publication
(10) Pub. No.: US 2018/0370582 A1
(43) Pub. Date: Dec. 27, 2018

(54) PERSONAL TRANSPORTER

(71) Applicant: cocoa motors. Inc., Tokyo (JP)

(72) Inventors: Kuniaki SATO, Tokyo (JP); Ryo MAEDA, Tokyo (JP); Seiya SATO, Tokyo (JP)

(21) Appl. No.: 15/779,668

(22) PCT Filed: Nov. 30, 2015
(86) PCT No.: PCT/JP2015/083598

§ 371 Date: May 29, 2018

(51) Int. Cl. B62D 51/02; B62K 17/00; B60B 33/00

(52) U.S. Cl. CPC B62D 51/02; B62K 17/00; B60B 33/0007; B60B 33/0026; B60B 33/0015

(57) ABSTRACT

An object of the invention is to provide a personal mobility that is able to turn by movement of the gravitational center of a passenger, without individually controlling each motor that drives the left and right wheels, and without using any special parts. The personal transporter includes left and right driving wheels (21) as front wheels, left and right casters (22) as rear wheels, and two motors (31) for independently driving the left and right driving wheels (21). By giving a camber angle, in which an upper part inclines inward when viewed from the front, with respect to the left and right casters (22), the torque or the applied voltage of the two motors (31) is the same, the caster (22) rotates in the direction of movement of gravitational center to act as a steering wheel, and it is possible to turn a personal transporter in the movement direction of the gravitational center.

### TECHNICAL FIELD

The present invention relates to a personal transporter, and more particularly, to a transporter that can be controlled to travel by movement of a center of gravity of a person.

### BACKGROUND ART

Conventionally, a so-called “personal mobility (personal transporter)” has been known as a new type of transporter which travels with one person. As an example of the personal mobility, a personal mobility of a style standing like a skateboard has been proposed (see, for example, Patent Documents 1 to 5).

In the personal mobility described in the Patent Documents 1 to 5, a traveling control can be performed by movement of the gravitational center of a person. That is, in the techniques described in the Patent Documents 1 to 5, the movement of personal mobility such as an angle of turning and a traveling speed is determined depending on a position on a board where the gravitational center is moved.

Specifically, the vehicle described in Patent Document 1 includes two driving motors that rotationally drive the left and right wheels, a pressure sensor which detects movement of the gravitational center of a passenger riding on a step board disposed between the left and right wheels, and a drive control unit which drives and controls the two driving motors on the basis of a detection signal from the pressure sensor to perform straight traveling and turning operations.

Also, a three-wheeled passenger moving carriage disclosed in Patent Document 2 includes an elastic body which connects a base and a riding table, a motor which independently drives a pair of front wheels, a rotation angle sensor which detects the rotation angle of the motor, a tilt angle sensor which detects a balance between the front-rear and the left-right directions of the base, a riding table tilt detection unit which detects a relative angle in the front-rear and the right-left directions with respect to the base of the riding table, and a control unit which detects the position of gravitational center of the user in the front-rear and left-right directions on the basis of the signals of each sensor, controls the movement acceleration in the front-rear direction using the signal indicating the position of gravitational center, and performs the operation control in the left-right direction.

Further, a unstable traveling device disclosed in Patent Document 3 includes two wheels disposed in parallel, two wheel driving units that rotationally drive the two wheels, a pair of riding decks on which the left and right feet of the driver are individually placed, a gyro sensor which detects a tilt angle in the traveling direction of the pair of riding decks, a rotation angle detector which detects a tilt angle in the direction of the axle of the pair of riding decks, and a control device which outputs a control signal to the two wheel drive units in accordance with the attitudes of the pair of riding decks detected by the gyro sensor and the rotation angle detector to control the traveling state.

In addition, the personal transporter disclosed in Patent Document 4 includes a plurality of load sensors provided on a board-like riding table, a gravitational center position detection unit which detects the presence or absence of load applied by the passenger and the position of gravitational center of the passenger on the riding table on the basis of the output signals from the plurality of load sensors, and a motor drive control unit which controls the driving of the two motors connected to the driving wheel, depending on the presence or absence of the load detected by the gravitational center position detection unit and the position of gravitational center.

Further, a vehicle described in Patent Document 5 includes two wheels provided with fluid chambers that are elastically deformable at least in part, and a vehicle body on which the two wheels are rotatably supported and a person rides, and the vehicle is steered by generating a difference in the turning radius between the fluid chambers of the two wheels by the movement of the gravitational center of the person who rides on the vehicle body.

In each of the personal mobility described in Patent Documents 1 to 4, the control device is configured to independently control the two motors that drive the left and right wheels with different torque on the basis of the output signal of the sensor. That is, the control is performed such that when turning to the right, the torque of the motor on the left wheel side is increased, and conversely, when turning to the left, the torque of the motor on the right wheel side is increased.

Here, how to control the torques of the left and right motors by the control device to what extent is determined in accordance with a control logic determined artificially beforehand. Therefore, the movement of the personal mobility intended or expected by the movement of the gravitational center of the passenger may not match the actual movement of the personal mobility controlled by the control device. Thus, there was a problem that it is relatively difficult for a passenger to steer the personal mobility according to his own intention.

In contrast, in the case of the personal mobility described in Patent Document 5, there is no sensor or a control device, and torque control of the left and right motors is unnecessary. That is, the personal mobility is configured to perform steering by generating a difference in the turning radius between the left and right fluid chambers, due to the difference in the load transmitted to the two wheels through the vehicle body by the movement of the gravitational center of the passenger. Therefore, the movement of the personal mobility can be attained in a form close to the movement intended or expected by the movement of the gravitational center of the passenger. However, in the technique described in Patent Document 5, because it is necessary to use a special wheel provided with a fluid chamber that is elastically deformable at least in part, there was a problem of an increase in the manufacturing cost.

Incidentally, it is known that there is a certain relation between the ground load acting on the left and right wheels and the turning property of the vehicle (for example, see Patent Documents 6 and 7). For example, Patent Document 6 discloses a technique for improving the turning performance, by changing the ground load acting on the left wheel of the vehicle and the ground load acting on the right wheel to a desired ratio.

Further, Patent Document 7 discloses a ground load application mechanism that causes a load of a passenger riding in a boarding portion to act on a tail wheel as a ground load. The ground load application mechanism is connected to an intermediate portion between a front end portion and a rear end portion of a wheel support frame such that the boarding portion frame can tilt back and forth. With this configuration, a part of the weight of the passenger acts on the tail wheel as a downward load, and the ground load of the tail wheel changes depending on the weight of the passenger. Thus, the ground load of the tail wheel becomes an appropriate value, regardless of the weight of the passenger, and good turning performance can be obtained.

Patent Document 1: JP2004-359094A

Patent Document 2: JP2006-256401A

Patent Document 3: JP2006-1384A

Patent Document 4: Japanese Patent No. 5470507

Patent Document 5: JP2004-345608A

Patent Document 6: JP2007-30566A

Patent Document 7: JP2014-15122A

### DISCLOSURE OF THE INVENTION

There is a need to provide personal mobility capable of performing the turning control by movement of the gravitational center of a passenger, without using a unit which individually controls the torque or applied voltage of each motor for driving the left and right wheels. However, in the technique described in Patent Document 5, as described above, because it is necessary to use a special wheel provided with an elastically deformable fluid chamber, there is a problem of an increase in the manufacturing cost.

Further, the technique described in Patent Document 6 is configured so that cornering power at the time of traveling of a four-wheeled vehicle can be secured to a maximal level, by changing the ground load acting on the left wheel of the vehicle and the ground load acting on the right wheel to a desired ratio. However, the technique cannot be applied to the turning control of the personal mobility.

Further, the technique described in Patent Document 7 is intended to improve the turning performance of a unicycle, and cannot be applied to the turning control of personal mobility provided with left and right wheels.

The invention has been made to solve such a problem, and an object thereof is to provide personal mobility capable of performing the turning control by movement of the gravitational center of the passenger, without using a unit which individually controls the torque or applied voltage by providing each motor to drive the left and right wheels, and without using any special part.

In order to solve the above-mentioned problems, the invention includes left and right driving wheels as front wheels, and two casters as rear wheels, and the two casters have a camber angle in which the upper part tilts inward when viewed from the front.

According to the invention configured as described above, when the passenger moves the gravitational center in the left-right direction, since the caster rotates in the movement direction of the gravitational center and acts as a steering mechanism, it is possible to turn the personal transporter in the direction of movement of the gravitational center. Therefore, it is possible to provide a personal transporter capable of performing the turning control by movement of the gravitational center of the passenger, without using a unit which individually controls the torque or applied voltage of each motor which drives the left and right wheels, and without using any special part.

### BRIEF DESCRIPTION OF THE DRAWINGS

FIG. 1 is a schematic perspective view illustrating an appearance of a personal transporter according to this embodiment.

FIG. 2 is a bottom view illustrating a power system of a personal transporter according to the embodiment.

FIG. 3 is a diagram illustrating an example of a gravitational center position detected by a control circuit of the embodiment.

FIG. 4 is a diagram illustrating a control example of a traveling speed and forward and backward traveling directions in accordance with a Y coordinate of the position of gravitational center.

FIG. 5 is a diagram illustrating an example of an attachment structure of a caster according to the embodiment.

FIG. 6 is a diagram illustrating another example relating to the attachment structure of the caster according to the embodiment.

FIG. 7 is a diagram illustrating another example of providing camber angle of the caster according to the embodiment.

FIG. 8 is a diagram illustrating another example relating to the attachment structure of the caster according to the embodiment.

FIG. 9 is a diagram illustrating another configuration example of the caster according to the embodiment.

FIG. 10 is a diagram illustrating another configuration example of the caster according to the embodiment.

FIG. 11 is a diagram illustrating another configuration example of a connecting member according to this embodiment.

FIG. 12 is a diagram illustrating another configuration example for driving a driving wheel according to the embodiment.

FIG. 13 is a diagram illustrating another configuration example for driving the driving wheel according to the embodiment.

### MODE FOR CARRYING OUT THE INVENTION

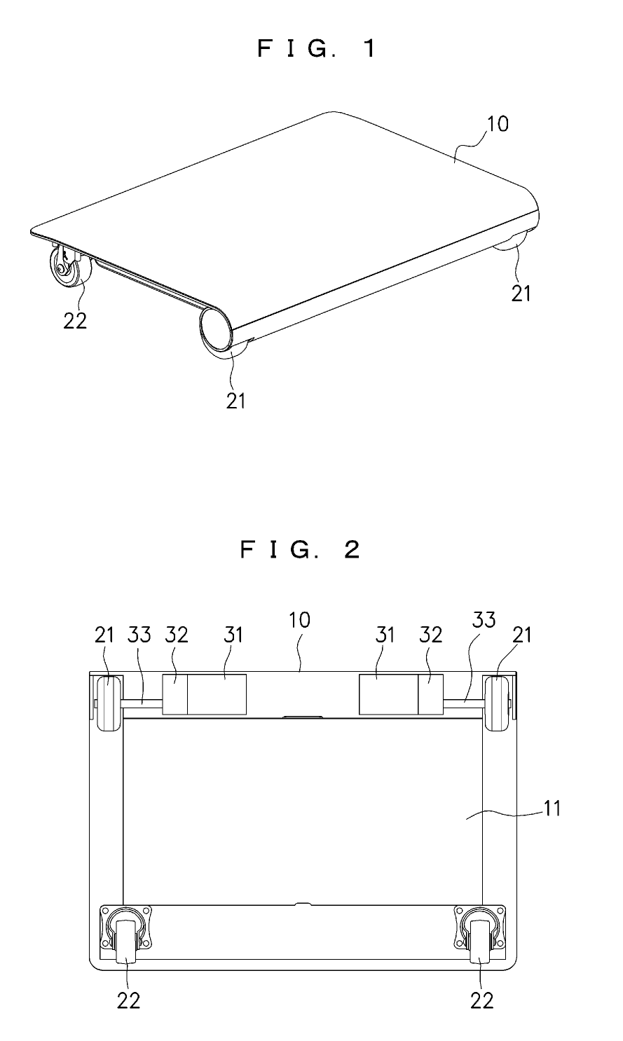

An embodiment of the invention will be described below with reference to the drawings. FIG. 1 is a schematic perspective view illustrating an external appearance of a personal transporter (personal mobility) according to this embodiment. FIG. 2 is a bottom view illustrating a power system of the personal transporter according to the embodiment. The power system illustrated in FIG. 2 illustrates a state in which an internal configuration is illustrated by seeing through the cover.

As illustrated in FIG. 1 and FIG. 2, the personal transporter of the embodiment is a configuration type in which a plurality of wheels 21 and 22 is provided under a board-like riding table 10, and is able to perform a traveling control by movement of the gravitational center of the passenger. That is, a passenger rides in a standing state while placing both feet on the riding table 10 and performs the movement of the gravitational center in the front-rear direction and the left-right direction, so that it is possible to control going straight, turning left and right, and the traveling speed.

The riding table 10 has a substantially rectangular flat surface, and four wheels 21 and 22 are attached to the vicinity of the four corners. As a result, it is possible to secure the traveling stability when the passenger gets on the personal transporter. Among the four wheels 21 and 22, the two front wheels 21 are driving wheels which are driven by the two motors 31 built in the riding table 10. The remaining two rear wheels 22 are types of casters that can rotate freely through 360 degrees.

Four wheels 21 and 22 are attached to the bottom of the riding table 10. Further, the riding table 10 includes two motors 31 which independently drive the left and right driving wheels 21, a connecting member 32 which connects the driving wheel 21 and the motor 31, a control circuit (not illustrated) and a battery (not illustrated) accommodated therein. The control circuit and the battery are accommodated in an accommodating box 11 provided on the bottom side of the riding table 10.

The personal transporter of the embodiment includes a plurality of load sensors (not illustrated). For example, in the plurality of load sensors, four load sensors are provided near the four corners of the riding table 10. Specifically, the riding table 10 is constituted by a chassis, and a top cover which covers the top of the chassis, and four load sensors are disposed between the chassis and the top cover. Here, by making rigidity of the chassis strong to be hard to be bent, and by making the top cover relatively flexible, when the passenger rides on the riding table 10 and applies weight to the top cover, the load applied to the top cover can be detected by the load sensor.

The control circuit accommodated in the accommodating box 11 inputs the output signals of the four load sensors, and controls the driving of the two motors 31 connected to the driving wheel 21. In the embodiment, the torque or the applied voltage applied to the two motors 31 is set to be the same on both sides in any case of going straight, turning right, and turning left. That is, the control circuit of the embodiment controls only the magnitude of the applied voltage to the two motors 31, and it is not necessary to perform a control such that the applied voltages of the two left and right motors 31 change depending on the turning direction.

In order to determine the magnitude of the applied voltage, the control circuit detects the presence or absence of load applied by the passenger and the position of gravitational center of the passenger on the riding table 10, on the basis of the output signals from the four load sensors. As an example, the control circuit detects the presence or absence of a weight on the basis of the output signals from the four load sensors, and detects the position of gravitational center by interpolation calculation.

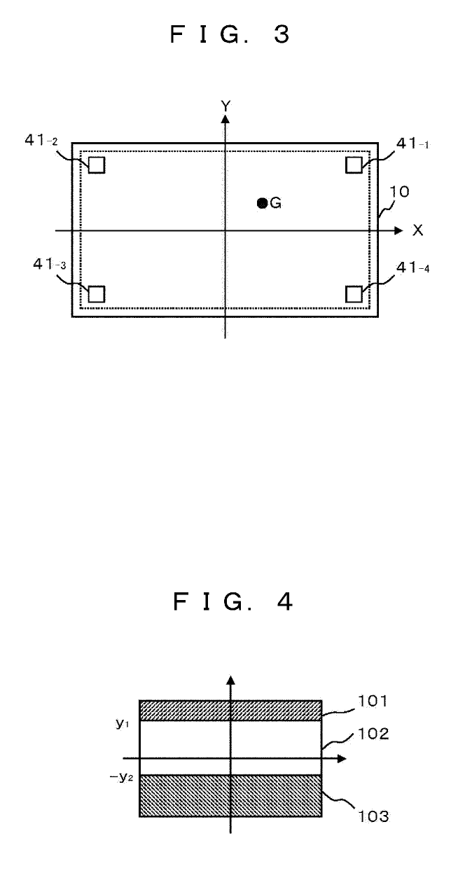

FIG. 3 is a diagram illustrating an example of the position of gravitational center detected by the control circuit. As illustrated in FIG. 3, two-dimensional coordinates (X-Y coordinates) with the center position of the riding table 10 as the origin are set on the plane of the riding table 10. In this case, each of the four load sensors 41 is located at the same distance from the origin.

On the coordinate plane illustrated in FIG. 3, the load sensors 41 arranged in a first quadrant to a fourth quadrant are distinguished by reference numerals 41₋₁ to 41₋₄, respectively. Here, the magnitudes (pressures) of the loads detected by the load sensors 41₋₁ to 41₋₄ are set to W₋₁ to W₋₄ respectively. Further, the distance in an X-axis direction from the origin to each of the load sensors 41₋₁ to 41₋₄ is set to x (any one is the same) and the distance in a Y-axis direction is set to y (any one is the same).

In this case, the position G of gravitational center (x_{G}, y_{G}) detected on the basis of the output signals W₋₁ to W₋₄ from the load sensors 41₋₁ to 41₋₄ is as follows:

x_{G}=x(W₋₁+W₋₄)/W−x(W₋₂+W₋₃₎/W

y_{G}=y(W₋₁+W₋₂)/W−y(W₋₃+W₋₄)/W

Herein, W=W₋₁+W₋₂+W₋₃+W₋₄

FIG. 4 is a diagram illustrating an example of control of the traveling speed or the forward and backward traveling directions performed depending on the Y coordinate of the position G of gravitational center. As illustrated in FIG. 4, regarding the Y coordinate of the position G of gravitational center, the values from the negative maximum value to the positive maximum value are divided into three regions 101 to 103, and the applied voltage (torque) of the motor 31 is controlled such that, when the position G of gravitational center exists in the first region 101 in which the value of the Y coordinate value is larger than y₁, acceleration is performed, when the position G of gravitational center exists in the third region 103 in which the value of the Y coordinate is smaller than −y₂, deceleration is performed, and when the position G of gravitational center exists in the second region 102 therebetween, the constant speed is obtained.

The control example illustrated here is only an example. For example, the first region 101 to the third region 103 are equally divided, and the applied voltage of the motor 31 may be controlled such that, when the position G of gravitational center exists in the first region 101, the forward movement is performed, when the position G of gravitational center exists in the second region 102, the stop is performed, and when the position G of gravitational center exists in the third region 103, the backward movement is performed. In this case, in the first region 101, as the value of the Y coordinate of the position G of gravitational center increases, the positive applied voltage to be applied to the motor 31 increases. Further, in the third region 103, as the value of the Y coordinate of the position G of gravitational center decreases (as the absolute value increases), the negative applied voltage to be applied to the motor 31 increases.

As described above, in the embodiment, only the traveling speed and the forward and backward traveling directions are controlled in accordance with the Y coordinate of the position G of gravitational center, and the control in the left-right direction is not performed. That is, the X coordinate of the position G of gravitational center is not used for drive control of the motor 31. Therefore, the X coordinate of the position G of gravitational center is not necessarily calculated. In this case, four load sensors may not be provided in the vicinity of the four corners of the riding table 10, and for example, only one load sensor may be provided in the front and rear respectively.

As described above, the two motors 31 independently drive the two driving wheels 21 under the control of the control circuit (however, the applied voltages to the two motors 31 are the same). As illustrated in FIGS. 1 and 2, the driving force of the two motors 31 is transmitted to the two driving wheels 21 via the two connecting members 32, respectively.

The connecting member 32 connects the motor 31 and the driving wheel 21. For example, the connecting member 32 has a configuration in which a gear (not illustrated) connected to a rotary shaft (not illustrated) of the motor 31 meshes with a gear (not illustrated) connected to an axle 33 of the driving wheel 21. As a result, the driving force of the motor 31 is transmitted to the driving wheel 21 via the gear of the connecting member 32.

Conversely, the ground pressure applied to the driving wheel 21 as a passenger gets on the riding table 10 is transmitted as a load to the motor 31 via the connecting member 32. Here, since the driving wheel 21 is attached to the bottom surface of the riding table 10, the ground pressure applied to the two driving wheels 21 changes depending on the position of gravitational center of the passenger riding on the riding table 10. The ground pressure applied to the two left and right driving wheels 21 acts as a load to the two motors 31 so that the rotational speeds of the two driving wheels 21 change.

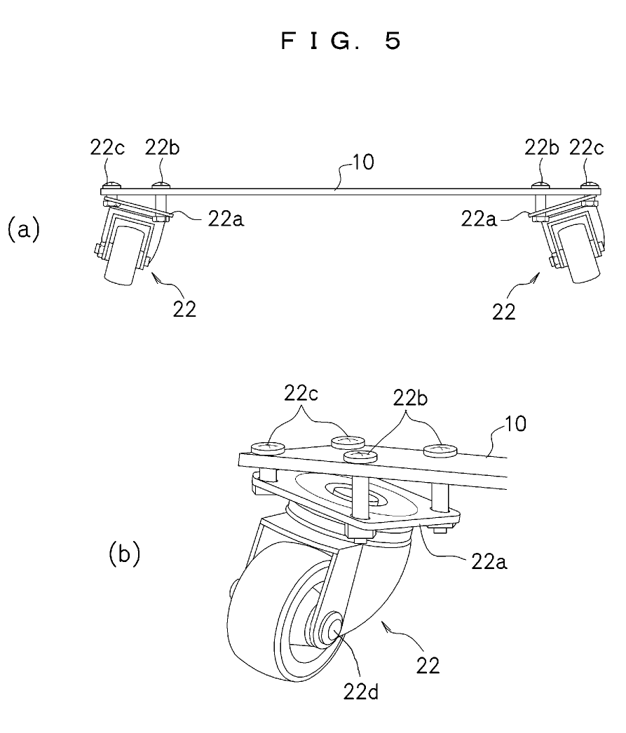

In the embodiment, in order to effectively perform the turning control in the left-right direction, the attachment structure of the rear wheel (caster) 22 is devised. FIG. 5 is a diagram illustrating an example of an attachment structure of the caster 22 according to the embodiment.

As illustrated in FIG. 5, the two casters 22 are attached to the riding table 10 so that the upper side has a camber angle inclined inward when viewed from the front. That is, in the embodiment, a negative camber angle that makes it appear as a reversed V-shaped letter when viewed from the front is attached to the left and right casters 22.

In the example of FIG. 5, when the four places of the plate 22a of the caster 22 and the riding table 10 are fixed with the four screws 22b and 22c, the inner screw 22b uses a long leg, and the outer screw 22c uses a short leg. As a result, a negative camber angle is given to the two casters 22.

The caster 22 is configured to be rotatable 360 degrees freely in parallel with the plate 22a. In the caster 22, a rotary shaft 22d of the wheel is eccentric to the rear of the attachment position of the four screws 22b and 22c to the riding table 10.

A method of providing the camber angle illustrated here is merely an example, and the invention is not limited thereto. For example, in the example of FIG. 5, the plate 22a is made up of a horizontal flat plate, but instead of this, a member in which the bottom surface (the surface attached to the riding table 10) is horizontal, and meanwhile, a camber angle is originally provided to the flat surface (the surface on which the wheel exists) may be used.

As described above, by giving a negative camber angle to the caster 22, since the caster 22 rotates in the movement direction of the gravitational center and acts as a steering wheel when the passenger moves the center of gravity in the left-right direction, it is possible to turn a personal transporter in the movement direction of the gravitational center.

For example, when the position of gravitational center of the passenger moves to the right side, the right caster 22, to which the load is applied more strongly, among the two casters 22 which are the rear wheel, receives the load and rotates toward the right side (outer side). For this reason, the wheel of the right caster 22 is oriented to the right more largely than when traveling straight and the personal transporter can be turned to the right.

On the other hand, when the position of gravitational center of the passenger moves to the left side, the left caster 22, to which the load is applied more strongly, among the two casters 22 which are the rear wheels, receives the load and rotates toward the left side (outer side). For this reason, the wheel of the left caster 22 is oriented to the left more largely than when traveling straight and the personal transporter can be turned to the left.

As described above, according to the embodiment, it is possible to control the steering angle (turning control in the left-right direction), while setting the applied voltages (torques) applied to the two motors 31 to the same. In the embodiment, by generating a difference in the rotational speeds of the left and right driving wheels 21 depending on the magnitude of the ground pressure applied to the left and right driving wheels 21 which is changed by the movement of the gravitational center of the passenger in the left-right direction, it is possible to make a more easily turnable state.

For example, when the position of gravitational center of the passenger moves to the right side, since the ground pressure of the right driving wheel 21 increases and the rotational speed decreases, and the rotational speed of the left driving wheel 21 increases, a state in which the personal transporter is more likely to turn toward the right direction is obtained. Conversely, when the position of gravitational center of the passenger moves to the left side, since the ground pressure of the left driving wheel 21 increases and the rotational speed decreases, and the rotational speed of the right driving wheel 21 increases, a state in which the personal transporter is more likely to turn toward the left direction is obtained.

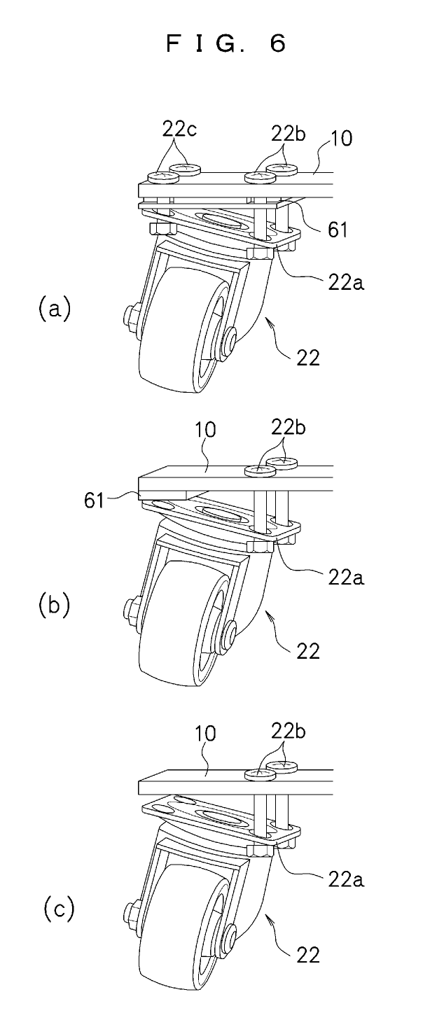

In addition to providing the camber angle to the caster 22, an elastic member may be provided between the riding table 10 and the caster 22. FIG. 6 is a diagram illustrating another example relating to the attachment structure of the caster 22 according to the embodiment. Here, three configuration examples are illustrated. In the example of FIG. 6(a), the four places of the plate 22a of the caster 22 and the riding table 10 are screwed by four screws 22b and 22c, and an elastic member 61 is provided between the substantially entire region (a region formed by four screwed places) of the plate 22a and the riding table 10.

In such a configuration, when a load is applied to the riding table 10 due to the movement of the gravitational center of the passenger, since the camber angle is increased due to the elastic deformation of the elastic member 61, the turning property in the left-right direction is improved. That is, when the load is applied downward to the riding table 10, the center portion of the riding table 10 bends downward. As a result, a downward force is also applied to the inside of the caster 22. At this time, since the camber angle is attached to the caster 22, upward stress is generated in the outer portion of the caster 22 due to the reaction of the downward force applied to the inside. As a result of the stress, the outer portion of the elastic member 61 is elastically deformed to be thin, and as a result, the camber angle of the caster 22 slightly increases. This improves the turning property in the left-right direction.

In the example illustrated in FIG. 6(b), the inner two places of the plate 22a of the caster 22 and the riding table 10 are screwed by two screws 22b, and the elastic member 61 is provided between the outer region of the plate 22a and the riding table 10. As described above, the outer portion of the elastic member 61 is elastically deformed by the weight applied to the riding table 10 by the passenger. Therefore, in the example of FIG. 6(b), the elastic member 61 is provided only in the outer region of the plate 22a.

Further, in the example of FIG. 6(b), since the outside of the plate 22a is not screwed, the upward stress generated in the outer portion of the plate 22a of the caster 22 due to the reaction caused by the weight applied to the riding table 10 is easily transmitted to the elastic member 61. As a result, a state in which the camber angle can be more easily changed is obtained.

In the example illustrated in FIG. 6(c), only by screwing only the inner two places of the plate 22a of the caster 22 and the riding table 10 with the two screws 22b, an elastic member may not be provided between the plate 22a and the riding table 10. Therefore, there is a gap between the outer portion of the plate 22a and the riding table 10.

In the case of such a configuration, because the outer portion of the plate 22a of the caster 22 is displaced upward due to the reaction caused by the weight applied to the riding table 10, the camber angle increases. When the elastic member 61 is provided, since it also functions as a cushioning material for absorbing impact during traveling, it is preferable to provide the elastic member 61 in that respect.

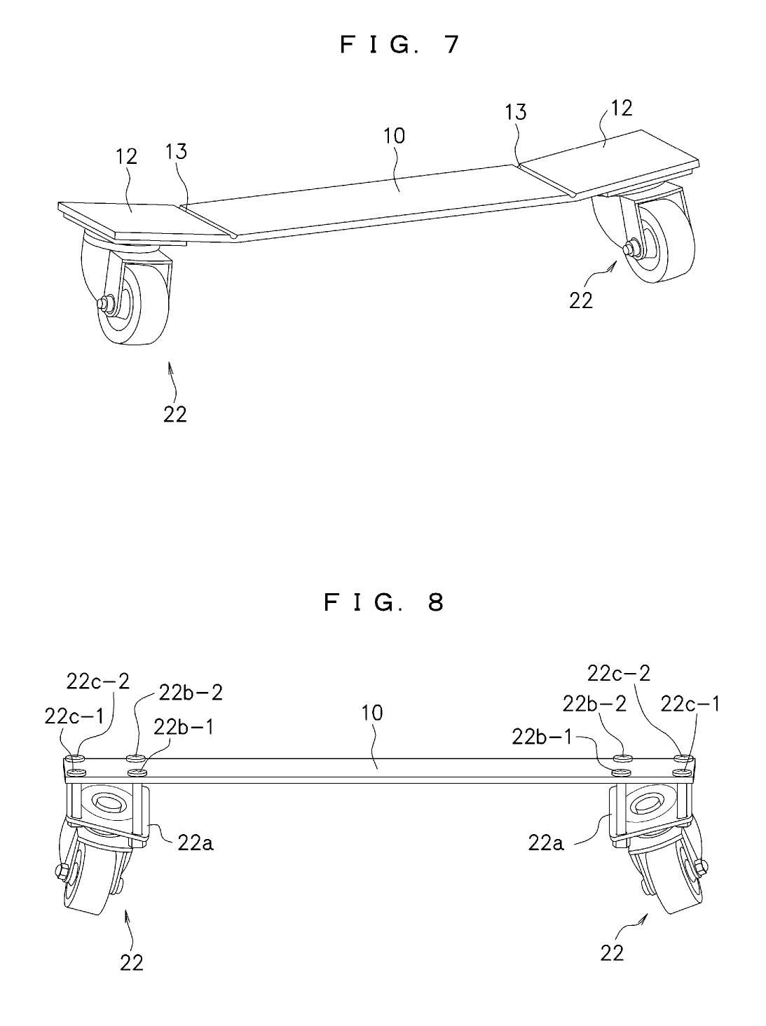

In the above description, the example in which the camber angle is provided by the method for attaching the casters 22 to the riding table 10 has been described, but the invention is not limited thereto. For example, as illustrated in FIG. 7, a camber angle may be provided to the riding table 10 itself. In the example of FIG. 7, the portion 12 of the riding table 10 to which the casters 22 are attached has a gradient that gradually decreases from the outside toward the inside when viewed from the front. By doing so, even when the caster 22 is normally attached to the riding table 10, the caster 22 can have a camber angle.

In the example illustrated in FIG. 7, U-shaped groove 13 is formed in a boundary portion between an inclined portion (inclined region) 12 in the outer region of the riding table 10 and a non-inclined portion in the central region of the riding table 10. As a result, when a downward load is applied to the central region inside the U-shaped groove 13 of the riding table 10, since the central region bends downward, and the inclined region 12 outside the U-shaped groove 13 is displaced upward due to the reaction, the camber angle of the caster 22 increases. This makes it possible to improve the turning property in the left-right direction. The shape of the groove is not limited to the U shape.

FIG. 8 is a diagram illustrating another example relating to the attachment structure of the caster 22 according to the embodiment. In the example illustrated in FIG. 8, the two casters 22 further have a caster angle in which the upper part tilts rearward when viewed from the side surface. In the example of FIG. 8, when the four places of the plate 22a of the caster 22 and the riding table 10 are screwed, the four screws 22b₋₁, 22b₋₂, 22c₋₁, and 22c₋₂ having the different leg lengths are used.

Here, the leg length is set as follows.

Outer front screw 22c₋₂<inner front screw 22b₋₂ outer rear screw 22c₋₁<inner rear screw 22b₋₁

Therefore, with respect to the two casters 22, a camber angle in which the upper part is inclined inward when viewed from the front is provided, and a caster angle in which the upper part is inclined backward when viewed from the side surface is provided.

By providing a caster angle to the caster 22, it is possible to increase the straightness of the personal transporter. As described above, when the camber angle is provided to the caster 22, the turning property in the left-right direction is improved. For this reason, there is a fear that the personal transporter turns in the left-right direction little by little due to the movement of the gravitational center in the left-right direction unintended by the passenger (such as when the balance is broken), resulting in unsteady traveling. On the other hand, when the caster 22 has a caster angle, since the straightness increases, it is possible to ensure the stability of traveling when traveling straight. That is, it is possible to avoid the problem that the caster 22 having the camber angle sensitively reacts with the slight movement of the gravitational center of the passenger to rotate in the left-right direction, resulting in unsteady traveling when traveling straight.

Further, when the caster 22 has the caster angle, it is possible to improve not only the traveling stability at the time of straight traveling but also the traveling stability at the time of turning. That is, by having the caster angle in addition to the camber angle, there is an advantage that it is possible to turn the personal transporter in a more stable state regardless of the speed at which the personal transporter is traveling. That is, it is possible to suppress the personal transporter from suddenly and excessively turning due to the effect of the camber angle, by the caster angle.

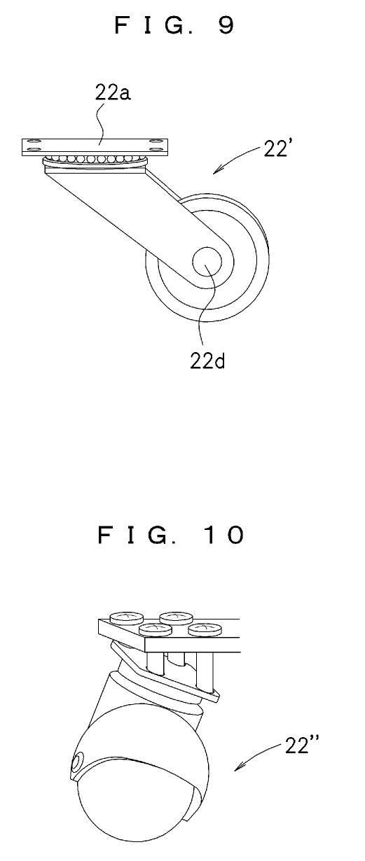

In the example illustrated in FIG. 8, an example in which the caster angle is provided by the method for attaching the caster 22 to the riding table 10 has been described, but the invention is not limited thereto. For example, as illustrated in FIG. 9, it is also possible to obtain the same effect as adding the caster angle by the structure of a caster 22′.

In the example of FIG. 9, in the caster 22′, a rotary shaft 22d of the wheel is greatly eccentric rearward of the position of the plate 22a to be attached to the riding table 10. That is, as compared with the casters 22 illustrated in FIGS. 5 to 7, the eccentric distance from the position of the plate 22a to the rotary shaft 22d of the wheel is made longer. By attaching the casters 22′ thus constituted as illustrated in FIG. 5 to FIG. 7, it is possible to provide the camber angle and the caster angle to the casters 22′.

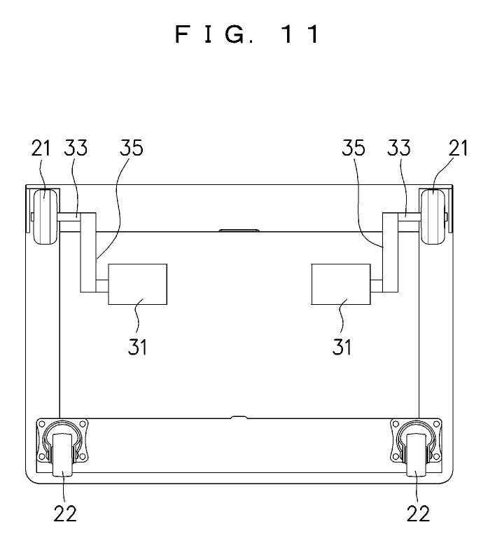

In the above embodiment, the casters 22 and 22′ may be two-wheel casters of the type in which two wheels are arranged in parallel and used like one wheel. A spherical caster 22″ as illustrated in FIG. 10 may also be used. FIG. 10 illustrates an example in which a camber angle and a caster angle are provided for the spherical caster 22″. In a case where the camber angle is given using the spherical caster 22″, since the caster 22″ rotates more smoothly when rotated outward due to the weight, it is also possible to secure the stability of traveling when turning in the left-right direction.

In the above embodiment, as an example of a connecting member which connects the driving wheel 21 and the motor 31, a connecting member 32 as illustrated in FIG. 2 (a configuration in which the axle 33 of the driving wheel 21 and the rotary shaft of the motor 31 are connected by a gear). However, the invention is not limited thereto. For example, as illustrated in FIG. 11, the rotary shaft of the motor 31 and the axle 33 of the driving wheel 21 may be connected by a timing belt 35 or the like.

Alternatively, the driving wheel 21 may be constituted by a caterpillar type configuration in which front and rear wheels are hung with a timing belt or the like, and the rotary shaft of the motor 31 is connected to one of the front and rear wheels.

Further, in the above embodiment, the example in which the two driving wheels 21 are independently driven by the two motors 31 has been described, but the invention is not limited thereto. For example, the two driving wheels 21 may be driven by one motor. In this case, it is possible to use a differential gear as an example of a connecting member which connects the two driving wheels 21 and one motor to drive the wheels. In this way, while driving the two driving wheels 21 with the same applied voltage (torque) by one motor, the rotational speed of the two driving wheels 21 can be changed by the change in the ground pressure applied to the two driving wheels 21 depending on the position of gravitational center of the passenger placed on the riding table 10.

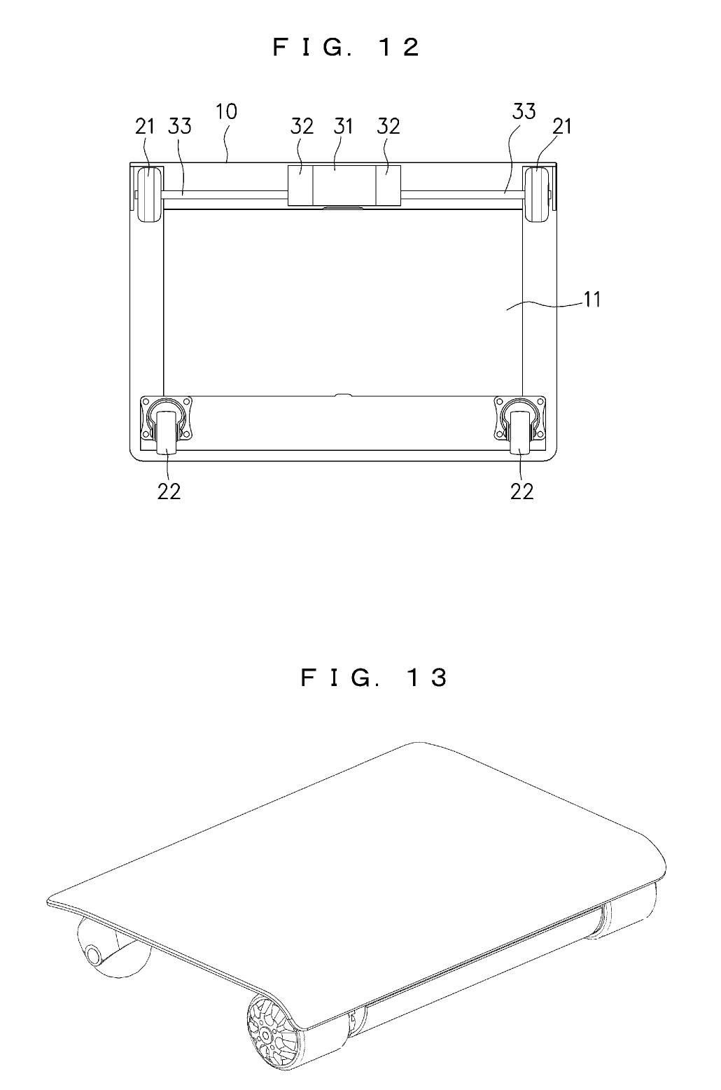

Alternatively, as illustrated in FIG. 12, the connecting members 32 may be provided on the left and right sides of one motor 31 so that two driving wheels 21 are driven by one motor 31. In this case, even when the ground pressure applied to the two driving wheels 21 changes depending on the position of gravitational center of the passenger on the riding table 10, the rotational speeds of the two driving wheels 21 do not change. However, since the caster 22 has a camber angle, it is possible to turn the personal transporter in the left-right direction by moving the gravitational center of the passenger.

Further, in the above-described embodiment, an example in which the driving wheel 21 and the motor 31 are connected by the connecting member has been described, but the invention is not limited thereto. For example, as illustrated in FIG. 13, by using an in-wheel motor, it is also possible to omit a connecting member between the driving wheel 21 and the motor.

Further, in the above-described embodiment, an example in which two driving wheels 21 as front wheels are provided on the left and right sides has been described, but it is also possible to provide only one wheel at the center.

Besides, each of the above-described embodiments is merely an example of a specific implementation for carrying out the invention, and the technical scope of the invention should not be interpreted limitedly. That is, the invention can be implemented in various forms without departing from the gist or the main features thereof.

### REFERENCE SIGNS LIST

10 Riding table
21 Driving wheel (front wheel)
22, 22′, 22″ Caster (rear wheel)
31 Motor
32 Connecting member

1. A personal transporter which is a configuration type in which wheels are provided under a riding table and which is capable of performing a traveling control by movement of a gravitational center of a passenger, the personal transporter comprises:
a plurality of wheels including a driving wheel as front wheel and left and right casters as rear wheels;
a motor which drives the driving wheel; and
the riding table to which the plurality of wheels is attached and which accommodates the motor,
wherein the left and right casters have a camber angle in which an upper part tilts inward when viewed from the front.

2. The personal transporter according to claim 1, wherein the left and right casters have caster angles in which an upper part tilts rearward when viewed from a side surface.

3. The personal transporter according to claim 1, wherein, instead of giving the camber angle to the left and right casters, a portion of the riding table to which the left and right casters are attached has a gradient which gradually decreases from the outside toward the inside when viewed from the front.

4. The personal transporter according to claim 1, wherein the left and right casters have a rotary shaft which is eccentric rearward of an attachment position to the riding table.

5. The personal transporter according to claim 1, wherein an elastic member is provided between the riding table and the caster.

6. The personal transporter according to claim 5, wherein inner two places of the plate of the caster and the riding table are screwed together, and the elastic member is provided between an outer region of the plate and the riding table.

7. The personal transporter according to claim 5, wherein the four places of the plate of the caster and the riding table are screwed together, and the elastic member is provided between a substantially entire region of the plate and the riding table.

8. The personal transporter according to claim 1, wherein two inner places of the plate of the caster and the riding table are screwed together, and a gap exists between an outer portion of the plate and the riding table.

9. The personal transporter according to claim 3, wherein a groove is formed at a boundary portion between an inclined region of the riding table and a non-inclined region of the riding table.

10. The personal transporter according to claim 1, wherein the front wheel include left and right driving wheels, and
a ground pressure applied to the left and right driving wheels is changed depending on a gravitational center position of the passenger, and the rotational speeds of the left and right driving wheels are changed by the ground pressure.

11. The personal transporter according to claim 2, wherein, instead of giving the camber angle to the left and right casters, a portion of the riding table to which the left and right casters are attached has a gradient which gradually decreases from the outside toward the inside when viewed from the front.

12. The personal transporter according to claim 3, wherein the left and right casters have a rotary shaft which is eccentric rearward of an attachment position to the riding table.

13. The personal transporter according to claim 11, wherein the left and right casters have a rotary shaft which is eccentric rearward of an attachment position to the riding table.

14. The personal transporter according to claim 2, wherein an elastic member is provided between the riding table and the caster.

15. The personal transporter according to claim 14, wherein inner two places of the plate of the caster and the riding table are screwed together, and the elastic member is provided between an outer region of the plate and the riding table.

16. The personal transporter according to claim 14, wherein the four places of the plate of the caster and the riding table are screwed together, and the elastic member is provided between a substantially entire region of the plate and the riding table.

17. The personal transporter according to claim 2, wherein two inner places of the plate of the caster and the riding table are screwed together, and a gap exists between an outer portion of the plate and the riding table.

18. The personal transporter according to claim 11, wherein a groove is formed at a boundary portion between an inclined region of the riding table and a non-inclined region of the riding table.

19. The personal transporter according to claim 2, wherein the front wheel include left and right driving wheels, and
a ground pressure applied to the left and right driving wheels is changed depending on a gravitational center position of the passenger, and the rotational speeds of the left and right driving wheels are changed by the ground pressure.

20. The personal transporter according to claim 5, wherein the front wheel include left and right driving wheels, and
a ground pressure applied to the left and right driving wheels is changed depending on a gravitational center position of the passenger, and the rotational speeds of the left and right driving wheels are changed by the ground pressure.
